(19) United States
(12) Patent Application Publication
(10) Pub. No.: US 2025/0371911 A1
(43) Pub. Date: Dec. 4, 2025

(54) SYSTEMS AND METHODS FOR DETERMINING POSSESSION OF MOBILE DEVICES HOLDING DIGITAL CREDENTIAL

(71) Applicant: HID Global Corp., Austin, TX (US)

(72) Inventors: Robert Kjell Rowe, Poulsbo, WA (US); Jing Ming, Abington, PA (US)

(21) Appl. No.: 18/874,953

(22) PCT Filed: Jun. 29, 2022
(86) PCT No.: PCT/US2022/073253

§ 371 Date: Dec. 13, 2024

(51) Int. Cl. G06V 40/70; G06V 10/774; G06V 10/82; G06V 20/40; G06V 20/50; G06V 40/10; G06V 40/20; G07C 9/25

(52) U.S. Cl. CPC G06V 40/70; G06V 10/82; G06V 20/40; G06V 20/50; G06V 40/10; G06V 40/20; G07C 9/25; G06V 10/774

(57) ABSTRACT

A method of operating a seamless physical access control (PAC) system includes receiving, by a verification device of the PAC system, credential information from a credential device; receiving inertial measurement unit (IMU) information from the credential device; receiving video data from another device different from the credential device, the video data including images of one or more persons; and correlating movement of the one or more persons detected in the video data with the received IMU information to identify a person in the video data as a holder in possession of the credential device.

### TECHNICAL FIELD

Embodiments illustrated and described herein generally relate to system architectures for physical access control systems.

### BACKGROUND

Seamless access control refers to when physical access is granted to an authorized user to a controlled space without requiring any affirmative action of the user, such as entering or swiping an access card at a card reader or entering a personal identification number (PIN) or password for example. A Physical Access Control (PAC) system can provide seamless access to a controlled or secured space (e.g., an office, manufacturing facility, retail establishment, arena, or residence) merely by the person being in possession of a credential device (e.g., a smartphone) that holds credential information with the right or permission to gain access to the space. Wireless technology can be used to determine that the credential is in proximity of the secured entry point and a secure wireless protocol can retrieve and validate the credential information stored in the device. If the credential information is validated and has the proper permissions, then the person holding the associated phone is allowed to enter the secured space. In some situations, there may be many people close together trying to enter a secured area. For example, at the start of a sporting event many people may try to enter the arena at a similar time. It is desirable to be able to match each credential to specific people while maintaining seamless access for those attending the event.

### BRIEF DESCRIPTION OF THE DRAWINGS

FIG. 1 is a flow diagram of an example of a method of operating a seamless physical access control (PAC) system.

FIG. 2 is an example of portions of a PAC system.

FIG. 3 is another example of portions of a PAC system.

FIG. 4 is a block diagram schematic of portions of an example of a verification device.

### DETAILED DESCRIPTION

Smart phones and other mobile devices may hold digital credential information that enables access to a secured physical space. The person seeking to enter the space may only need to be in possession of the mobile device that holds credential information with the correct permissions and may not be required to use an app or take any type of affirmative action to be authorized to enter the space. Instead, a wireless technology such as Bluetooth™ may be used to determine that the mobile device is in proximity of the secured entry point. A secure wireless protocol can be initiated to retrieve and validate the credential information from the mobile device. If the credential information is validated and has the proper permissions, then the person holding the associated mobile device is allowed to pass through a physical access portal (e.g., a secured door) to enter the secured space.

In some situations, there may be many people close together trying to enter a secured area at a similar time, such as at the start of a sporting event or other entertainment event. If mobile device-based credentials are being used for authorization, then it is important to be able to match each access credential to a specific person.

Some mobile devices include an inertial measurement unit (IMU). The IMU includes sensors (e.g., one or more of a three-axis accelerometer, a three-axis gyroscope, and a magnetometer) that generate electrical signals proportional to acceleration, angular velocity, acceleration due to gravity, and the earth's magnetic field. The electrical signals provide information related to motion of the mobile device and to orientation of the mobile device. Video can be available at the secured entry point that provides a video stream of people moving toward the entry point. The motion information from the mobile device can be associated with motion of people in the video stream to match a holder of a detected mobile device with a specific access credential to a person in the video stream. Once the association between mobile devices and people is made, specific people can be identified as holding specific access credentials contained on the corresponding mobile devices. Further, any person in the video for whom there is no associated set of IMU signals may be identified as not holding a properly enabled device, and the person may be processed in some manner differently than people for whom the association was made.

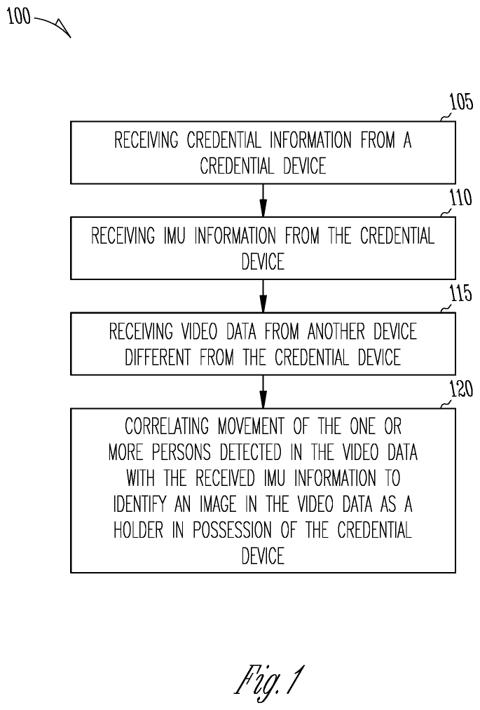

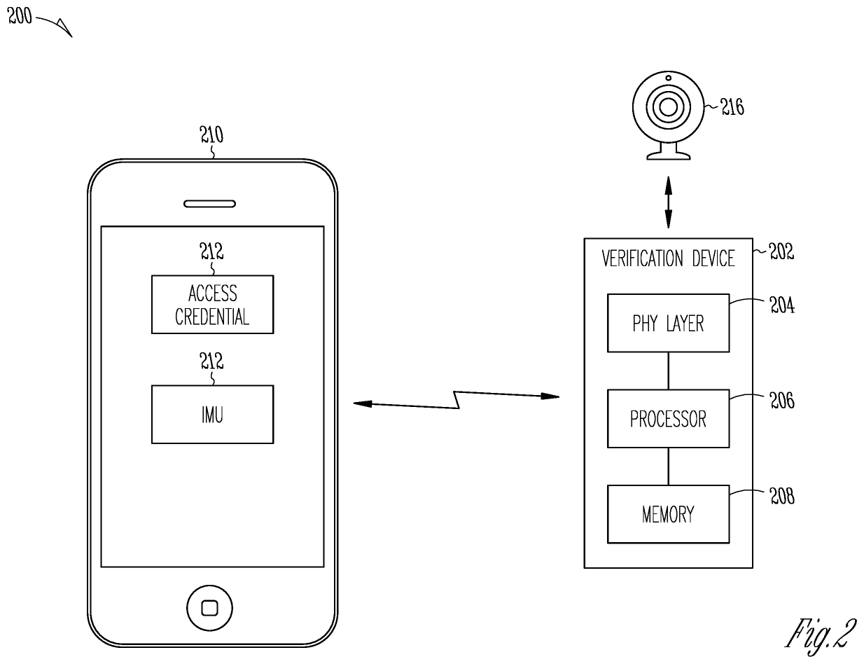

FIG. 1 is a flow diagram of an example of a method 100 of operating a seamless physical access control (PAC) system. FIG. 2 is an example of portions of a PAC system 200. The system 200 includes a verification device 202 and a video camera 216. The verification device 202 includes physical (PHY) layer circuitry 204, one or more hardware processors 206, and memory 208. The memory 208 stores executable instructions that cause the one or more hardware processors 206 to perform operations described herein. The PHY Layer 204 transmits and receives radio frequency electrical signals.

At block 105 in FIG. 1, the verification device 202 receives credential information from a credential device 210. In the example of FIG. 2, the credential device 210 is a smartphone and the credential information is a digital access credential 212 stored in the smartphone. The credential device may be any device that can store a digital credential and includes an IMU 214 (e.g., an exercise monitor, smart watch, etc.). At block 110 in FIG. 1, the verification device 202 also receives IMU information produced by the IMU 214 of the credential device 210. The IMU information may be a sampled IMU signal containing information of motion (e.g., one or both of acceleration and velocity) of the credential device 210.

At block 115, the verification device 202 receives video data from a device different from the credential device 210, such as the camera 216 in FIG. 2. The video data can include a sequence of video image frames of a controlled access portal. The video sequence includes images of one or more persons walking or otherwise in motion. The verification device 202 processes the video sequence to detect an image of a person in the video data. At block 120, the verification device 202 correlates movement of the person in the video data with the received IMU information to identify that the image in the video data is the holder in possession of the credential device 210. Once the correlation is made and the access credential 212 validated, the verification device 202 initiates granting the access allowed by the access credential.

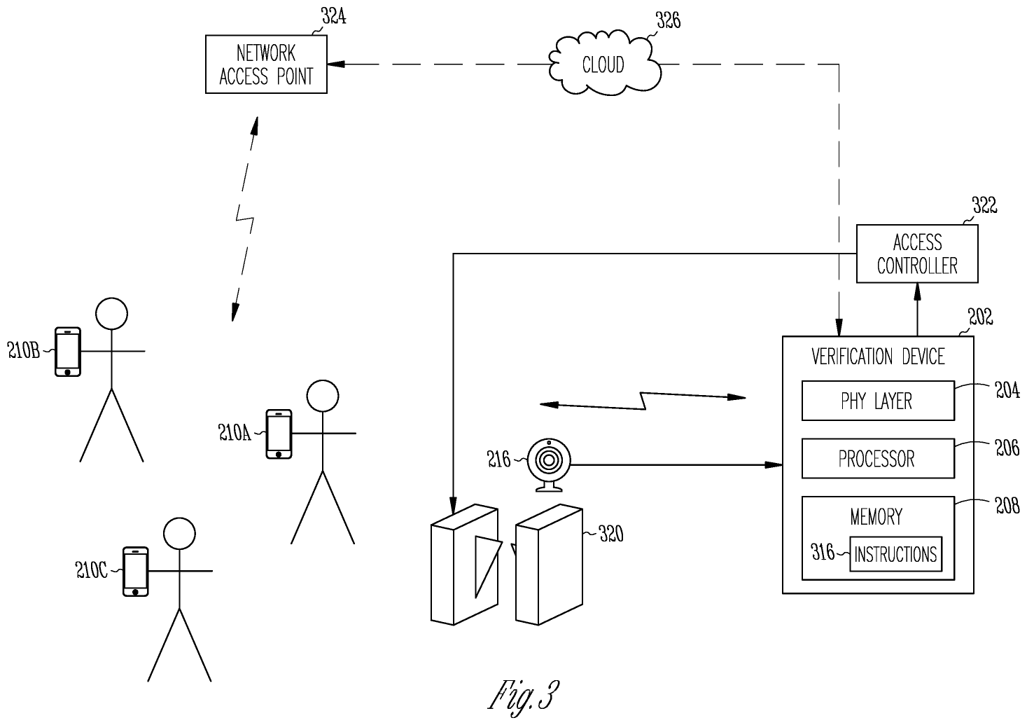

FIG. 3 is a diagram of another example of a physical access control (PAC) system 300 that authenticates rights or permission to pass through a controlled access portal using a credential device. In this example, the controlled access portal is a turnstile 320 or similar access portal, such as but not limited to, a gate, revolving door, etc. The PAC system 300 includes an access controller 322 and a verification device 202. The access controller 322 grants access through the turnstile 320 to a secured space in response to a signal or message from the verification device 202. In some examples, the verification device 202 performs the functions of the access controller 322. In the example of FIG. 3, multiple people are approaching the turnstile 320 with credential devices (210A, 210B, 210C) that are again smartphones or similar devices. The verification device 202 sets up communication sessions (that may be secure) with the credential devices (210A, 210B, 210C) approaching the turnstile 320 to retrieve the access credential stored in the devices. Alternatively, the credential devices (210A, 210B, 210C) transmit information to a network access point 324 (e.g., a LAN or WAN, such as an Internet access point) and may communicate with the verification device 202 through a cloud computing resource 326 for example.

The verification device 202 matches the received access credentials with the correct credential device (210A, 210B, 210C). The credential devices (210A, 210B, 210C) send IMU information and credential information to the verification device 202, and the camera 216 sends a video sequence of the scene at the turnstile 320 to the verification device 202. The processor 206 of the verification device 202 processes the video frames of the video sequence to detect images of a person who may be holding or otherwise in possession of a credential device (e.g., 210A) sending an access credential and IMU information associated with the access credential. The processor 206 correlates a detected image of a person to the IMU information to match the IMU information to the movement of the detected person. The one or more processors 206 then match the access credential to the person identified as the holder of the corresponding credential device (e.g., 210A).

Once the verification device 202 has matched the person to the access credential, the verification device 202 may take different actions depending on the implementation. In the example of FIG. 3, the turnstile 320 may be used to control access to a secured space such as an office. The verification device 202 may initiate the process to grant access to the holder of the credential device when the access credential is valid and the holder nears the turnstile 320. The verification device 202 may send a signal to the access controller 322 to release a lock on the turnstile. In some examples, the verification device 202 presents identification of the holder on a display of a user interface (not shown in FIG. 3) of the PAC system 300. The identification may include one or both of a name of the holder and an image of the holder. Security personnel may monitor the display to manage access through the turnstile 320.

In some examples, the correlation of access credentials to persons in the video sequence can be used to exclude someone from entry. The verification device 202 may detect a person in the video sequence not correlated to a credential device (e.g., 210A, 210B, 210C), or correlated with a credential device with an invalid access credential. The verification device 202 may not allow access by the person when the person nears the access portal. In some examples, the verification device presents identification of the person on the display or generate an alert regarding the detected person. Other means can then be used to grant or deny access to the detected individual.

To match persons in the video sequence to IMU signals from credential devices (210A, 210B, 210C), the verification device 202 correlates movement of one of the detected persons in the video sequence to one of the IMU signals received. Different methods can be used to correlate the movement of a person in the video with the IMU signal sent by the person's credential device (e.g., 210A).

A video sequence of a person who is walking or otherwise in motion can be processed by the verification device 202 to detect persons in the video frames of the sequence. To detect a person, the one or more body key points of the person (e.g., ankles, knees, hips, hands, elbows, neck, head, etc.) may be detected and tracked across video frames within the video sequence. Motion of the person is detected using the tracked body key points. If multiple people are present in the video sequence, then the verification device 202 may segment portions of the video frames containing each person and process the segmented portions separately to extract body key points for a single person.

Alternatively, the verification device 202 may process each image frame of the video sequence to extract all body key points of all people present in the image frame at once. The extracted body key points can be then grouped, tracked, and properly associated with each person in the image. In this example, the sequence of coordinates in the video frames of a particular body key point (e.g., coordinates of the right knee) acquired for a particular person over a video sequence represents one video feature having an identified motion. The coordinates of the body points may be further normalized to remove the temporal drift on 2D video frame sequence and signify the vibrating motion pattern. In some examples, this normalization process can be based on the coordinates of the bonding box for individual person in the frame. In other examples, the central point of the body may be used for the normalization process.

In another approach, one or more machine learning algorithms can be used to extract video features from the video sequence in a more general and abstract way to detect a motion pattern of persons in the video sequence. For example, a deep learning network or other neural network may be used to extract the video features showing motion. The neural network may be pre-trained to detect a person and extracting key body points. A neural network includes multiple network layers including an input layer, one or more hidden activation layers, and an output layer. Activation values from an activation layer just prior to the classification or regression output of the deep network can be recorded or stored. Each activation value can represent an image feature, and a sequence of such values can represent a video feature. If there are multiple persons in the video, the frame sequence may need to be segmented first to group each person's motion part together. These segmented person-specific video frames can serve as the inputs to a motion feature extracting neural network.

The IMU information received by the verification device 202 also includes motion information. Because the person is moving while carrying the credential device (e.g., 210A), the three-axis accelerometers and gyroscopes of the IMU of the credential device (e.g., 210A) will respond to the various accelerations and turns that the person is making. Each step that a person takes can strongly affect one or more of the accelerometer signals, while any turns that the person makes can strongly affect one or more of the gyroscope signals. These raw accelerometer and gyroscopic signals can provide information relative to the credential device's orientation. Additionally, the acceleration due to gravity as well as the earth's magnetic field can be sensed by the IMU magnetometer and may be used to convert the raw accelerometer and gyroscopic signals to signals in an absolute coordinate system. The carrier of a credential device (e.g., 210A) is then identified by finding the motion of a person in the video sequence that most closely corresponds to the IMU information from the credential device. For example, the verification device 202 can identify steps taken by a person in the video and associate the steps in the video sequence to the IMU accelerometer signal showing steps that match those in the video sequence.

Determining if a set of IMU signals correspond with motion of a single individual seen moving in a video sequence may be performed in a variety of ways. One approach is to calculate correlation coefficients between all video features and all IMU signals. The resulting coefficients may then be analyzed to determine the likely association between credential devices and people by looking for those cases where the calculated correlation coefficients indicate that one or more IMU signals correlate strongly with the motion of one or more body key points of the person. There may be a phase or temporal shift between the IMU signal and video motion that needs to be considered when calculating the correlation. In some examples, this systematic phase shift can be defined via a calibration process. A synchronization gap between a single subject's IMU signals and video frames can be used as a fixed phase shift for a PAC system. In other examples, methods like Fourier transform and cross-correlation can also reduce the noise introduced by phase shift.

In some scenarios, the video sequence of a person or persons in motion may introduce significant image artifacts due to changes in magnification for example or due to other optical distortions as the person changes their position with respect to the video camera. The image artifacts might affect the apparent association between the IMU signals and the video features using correlation or other association methods. In those cases, a variety of techniques may be used to process the video sequence to compensate for optical distortions. For example, rather than comparing raw feature values directly, a Fourier transform may be applied to each video feature sequence. Optical distortions such as changes in magnification will primarily affect the magnitude of the Fourier coefficients. The maximum frequency (e.g., maximum power spectrum value) for each video feature and IMU feature sequence can be determined. The resulting temporal frequencies and phases determined for the video features and the IMU signal features may then be compared (e.g., by correlation) to find associations between people and credential devices.

A more general and abstract approach of machine learning can also be used to associate motion of a person in a video sequence to a set of IMU signals. The memory 208 can include instructions 316 that when performed by the processor 206 cause the verification device 202 to implement a machine learning classification model. For example, the verification device 202 may implement a deep learning neural network that compares a linear or nonlinear combination of video features to a linear or nonlinear combination of IMU signals. The deep learning neural network make take in the video features as input to one portion of the network and take in the received IMU signals as input to another portion of the network. After the signals pass through an appropriate number of respective network layers, the resulting outputs may be concatenated, and the concatenated outputs are entered into a final classification portion of the network.

Such a machine learning model could be trained using labeled data as feedback (e.g., data where the IMU signals are known to correspond or to not correspond to the motion in the associated video sequence). For example, training data can be applied to minimize a cost function and optimize the weights of neural network connections through backpropagation process. The neural network and weights of connections of layers of the neural network can be updated using feedback information of the correctness of correlation of the training IMU information and video data.

As an alternative to having different explicit portions of the neural network associated with the video features and the IMU signals, the neural network could take in both types of data directly into a fully connected input layer or other configuration that allows the video data and the IMU data to be directly mixed. However, a network configuration of this type may be more prone to finding spurious numeric relationships among the raw data (which can be called “over fitting”). A larger set of training data may need to be applied to this type of network before the neural network performs well.

In some examples, a collaborative machine learning model is used to associate motion of a person in a video sequence to a set of IMU signals. Instead of training a neural network using centralized training data on one machine or data center, multiple devices use their own data to collaboratively learn a shared classification model while keeping the training data local to the devices. An example is federated learning. In federated learning, the multiple devices are mobile devices such as mobile phones. Each mobile phone downloads the current classification model and improves the model by learning improved classification using the data of the mobile phone as training data. Only the improvement to the classification model is then uploaded from the mobile phone and the improvement is averaged with updates from other mobile phones to improve the collaborative model. The training data remains local to the mobile phone. Federated learning can allow each local model to train itself using its own usage data and only output an encrypted model weight change (or gradient) to the central classification model. By doing so, federated learning avoids the data privacy issue and doesn't need a central data storage space for holding large amount of usage data or training data.

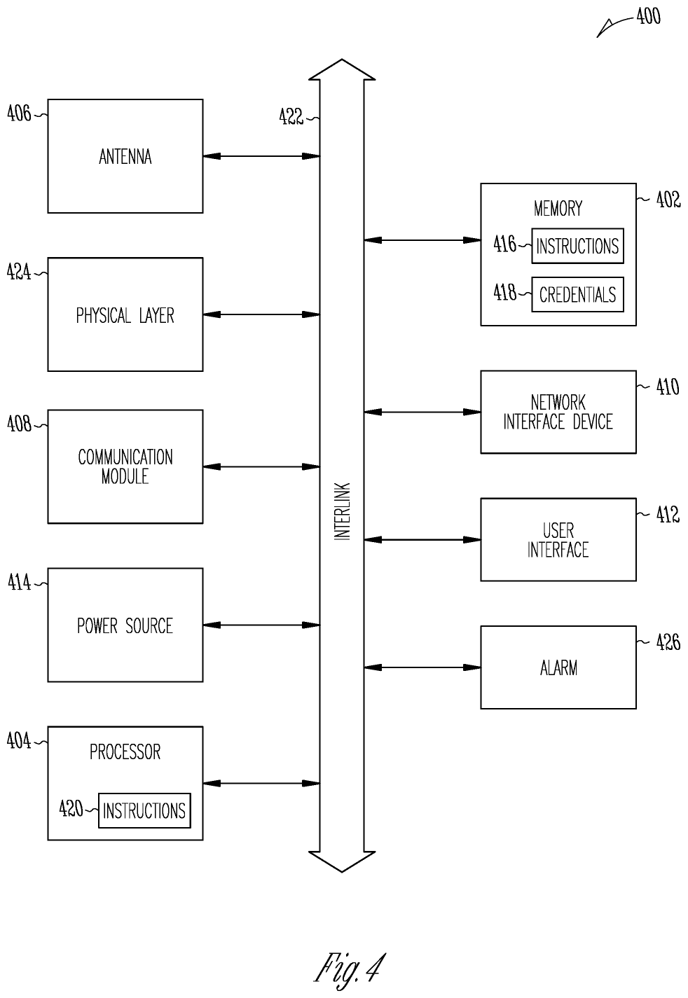

FIG. 4 is a block diagram schematic of various example components of an authorization or verification device for supporting the device architectures described and illustrated herein. The device 400 of FIG. 4 could be, for example, a verification device (e.g., the verification device 202 of FIG. 2) that analyzes evidence of authority, status, rights, and/or entitlement to privileges for a holder of a credential device. At a basic level, a credential device (e.g., 210A) can be a portable device having memory, storing one or more user credentials or credential data, and an interface (e.g., one or more antennas and Integrated Circuit (IC) chip(s)), which permit the credential device to exchange data with another device, such as a verification device. The credential device also includes an inertial measurement unit (IMU). One example of credential device is a smartphone that has data stored thereon allowing a holder of the credential device to access a secure area or asset protected by a reader device. Another example of a credential device is a smartwatch that has the data stored in memory.

With reference specifically to FIG. 4, examples of a verification device 400 for supporting the device architecture described and illustrated herein may generally include one or more of a memory 402, a processor 404, one or more antennas 406, a communication module 408, a network interface device 410, a user interface 412, and a power source 414 or power supply.

Memory 402 can be used in connection with the execution of application programming or instructions by processor 404, and for the temporary or long-term storage of program instructions or instruction sets 416, authorization data 418, such as credential data, credential authorization data, or access control data or instructions, as well as any data, data structures, and/or computer-executable instructions needed or desired to support the above-described device architecture. For example, memory 402 can contain executable instructions 416 that are used by the processor 404 to run other components of device 400, to make access determinations based on credential or authorization data 418, to implement a machine learning model, and/or to perform any of the functions or operations described herein, such as the method of FIG. 1 for example. Memory 402 can comprise a computer readable medium that can be any medium that can contain, store, communicate, or transport data, program code, or instructions for use by or in connection with device 400. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer readable media includes, but is not to be confused with, computer readable storage medium, which is intended to cover all physical, non-transitory, or similar embodiments of computer readable media.

Processor 404 can correspond to one or more computer processing devices or resources. For instance, processor 404 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 404 can be provided as a microprocessor, Central Processing Unit (CPU), or plurality of microprocessors or CPUs that are configured to execute instructions sets stored in an internal memory 420 and/or memory 402.

Antenna 406 can correspond to one or multiple antennas and can be configured to provide for wireless communications between device 400 and another device. Antenna(s) 406 can be arranged to operate using one or more wireless communication protocols and operating frequencies including, but not limited to, the IEEE 802.15.1, Bluetooth™, Bluetooth Low Energy (BLE), near field communications (NFC), ZigBee, GSM, CDMA, Wi-Fi, RF, UWB, and the like.

Device 400 may additionally include a communication module 408 and/or network interface device 410. Communication module 408 can be configured to communicate according to any suitable communications protocol with one or more different systems or devices either remote or local to device 400. Network interface device 410 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 410 can include an Ethernet port or other physical jack, a Wi-Fi card, a Network Interface Card (NIC), a cellular interface (e.g., antenna, filters, and associated circuitry), or the like. In some examples, network interface device 410 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 406, communication module 408, and/or network interface device 410 or subcomponents thereof, may be integrated as a single module or device, function or operate as if they were a single module or device, or may comprise of elements that are shared between them.

User interface 412 can include one or more input devices and/or display devices. Examples of suitable user input devices that can be included in user interface 412 include, without limitation, one or more buttons, a keyboard, a mouse, a touch-sensitive surface, a stylus, a camera, a microphone, etc. Examples of suitable user output devices that can be included in user interface 412 include, without limitation, one or more LEDs, an LCD panel, a display screen, a touchscreen, one or more lights, a speaker, etc. It should be appreciated that user interface 412 can also include a combined user input and user output device, such as a touch-sensitive display or the like. Alarm circuit 426 may provide an audio signal to a speaker or may activate a light or present an alarm condition using a display device.

Power source 414 can be any suitable internal power source, such as a battery, capacitive power source or similar type of charge-storage device, etc., and/or can include one or more power conversion circuits suitable to convert external power into suitable power (e.g., conversion of externally supplied AC power into DC power) for components of the device 400.

Device 400 can also include one or more interlinks or buses 422 operable to transmit communications between the various hardware components of the device. A system bus 422 can be any of several types of commercially available bus structures or bus architectures.

The systems, methods, and devices described herein can be used to provide access to secured physical spaces. The person seeking entry may only need to be in possession of a credential device such as a smartphone having an access credential stored thereon. The access credential can be associated with the correct access credential in the event of many people approaching the portal to the secured physical space at the same time.

### Additional Disclosure and Examples

Example 1 includes subject matter (such as a method of operating a seamless physical access control (PAC) system) including receiving, by a verification device of the PAC system, credential information from a credential device; receiving inertial measurement unit (IMU) information from the credential device; receiving video data from another device different from the credential device, the video data including images of one or more persons; and correlating, by the verification device, movement of the one or more persons detected in the video data with the received IMU information to identify a person in the video data as a holder in possession of the credential device.

In Example 2, the subject matter of Example 1 optionally includes identifying body key points of a person of the one or persons in the images of the video data; calculating correlation coefficients that correlate movement of the identified body key points and the received IMU information; and identifying the person in the video data as the holder according to the calculated correlation coefficients.

In Example 3, the subject matter of one or both of Examples 1 and 2 optionally includes determining a change in one or both of frequency and phase of movement of one or more body key points in images of the video data; determining a change in one or both of frequency and phase of the IMU information; and correlating the change in the one or both of frequency and phase of the IMU information with the change in one or both of frequency and phase of movement of the one or more body key points in images of the video data to identify the holder in the images of the video data.

In Example 4, the subject matter of one or any combination of Examples 1-3 optionally includes training a machine learning model, implemented by one or more processors of the PAC system, using correlated training IMU information and video data; inputting the IMU information received from the credential device and the video data received from the separate device into the machine learning model; detecting images of the one or more persons in the video data using the machine learning model; and matching the IMU information to the detected images using the machine learning model to identify the holder in possession of the credential device.

In Example 5, the subject matter of Example 4 optionally includes inputting the IMU information received from the credential device into one portion of the neural network and inputting the video data received from the separate device into a second portion of the neural network.

In Example 6, the subject matter of one or both of Examples 4 and 5 optionally includes updating weights of connections of a neural network using the correlated training IMU information and video data to update the neural network; and matching the IMU information to the detected images using the updated neural network.

In Example 7, the subject matter of one or any combination of Examples 1-6 optionally includes authenticating the credential information; processing subsequent video data that includes the holder of the credential device; and initiating access to a controlled access portal according to the credential information and the location of the holder of the credential device relative to the controlled access portal.

In Example 8, the subject matter of one or any combination of Examples 1-7 optionally includes receiving credential information from multiple credential devices; identifying holders of the multiple credential devices in the video data that includes images of multiple persons; and generating an alert when detecting a person of the multiple persons in the video data that is not in possession of a credential device.

In Example 9, the subject matter of one or any combination of Examples 1-8 optionally includes presenting identification of the identified holder of the credential device on a display of a user interface of the PAC system.

Example 10 includes subject matter (such as a verification device) or can optionally be combined with one or any combination of Examples 1-9 to include such subject matter, including physical layer circuitry configured to transmit and receive radio frequency electrical signals with a radio access network; at least one hardware processor operatively coupled to the physical layer circuitry; and memory. The memory stores instructions that cause the at least one hardware processor to perform operations including establish a communication session with a credential device using the radio access network; receive credential information from the credential device; receive inertial measurement unit (IMU) information from the credential device; obtain video data generated by a device different from the credential device; correlate movement of an image of a person in the video data with the received IMU information; and identify the person in the video data as a holder in possession of the credential device.

In Example 11, the subject matter of Example 10 optionally includes instructions to cause the at least one hardware processor to identify body key points of a person of the one or persons in the images of the video data; calculate correlation coefficients that correlate movement of the identified body key points and the received IMU information; and identify the person in the video data as the holder according to the calculated correlation coefficients.

In Example 12, the subject matter of one or both of Examples 10 and 11 optionally includes instructions to cause the at least one hardware processor to determine a change in one or both of frequency and phase of movement of one or more body key points in images of the video data; determine a change in one or both of frequency and phase of the IMU information; and correlate the change in the one or both of frequency and phase of the IMU information with the change in one or both of frequency and phase of movement of the one or more body key points in images of the video data to identify the holder in the images of the video data.

In Example 13, the subject matter of one or any combination of Examples 10-12 optionally includes instructions to cause the at least one hardware processor to perform a machine learning model to identify the holder in possession of the credential device in the video data. The operations of performing the machine learning model include receiving correlated training IMU information and video data; updating the machine learning model using the training IMU information and video data; applying the IMU information received from the credential device to the machine learning model; applying the video data received from the separate device to the machine learning model; detecting images of the one or more persons in the video data using the machine learning model; and matching the IMU information to the detected images using the machine learning model to identify the holder in possession of the credential device.

In Example 14, the subject matter of Example 13 optionally includes instructions cause the at least one hardware processor to implement a neural network to identify the holder in possession of the credential device in the video data. The operations of implementing the neural network include updating the neural network by updating weights of connections of the neural network using feedback information of the correctness of correlation of the training IMU information and video data; and matching the IMU information to the detected images using the updated neural network.

In Example 15, the subject matter of one or any combination of Examples 10-14 optionally include instructions to cause the at least one hardware processor to authenticate the credential information; process subsequent video data that includes the holder of the credential device; and initiate access to a physical access portal according to the credential information and the location of the holder of the credential device relative to the physical access portal.

In Example 16, the subject matter of one or any combination of Examples 10-15 optionally include instructions to cause the at least one hardware processor to receive credential information from multiple credential devices; identify holders of the multiple credential devices in the video data; and generate an alert when detecting a person of the multiple persons in the video data that is not in possession of a credential device.

In Example 17, the subject matter of one or any combination of Examples 10-16 optionally includes instructions to cause the at least one hardware processor to present identification of the holder of the credential device on a display of a user interface of the PAC system.

In Example 18, the subject matter of one or any combination of Examples 10-17 optionally includes a camera to generate the video data.

Example 19 includes subject matter (or can optionally be combined with one or any combination of Examples 1-18 to include such subject matter) such as a computer-readable storage medium including instructions that, when executed by one or more processors of a machine, configure the machine to perform operations including receiving credential information from a credential device; receiving inertial measurement unit (IMU) information from the credential device; receiving video data from another device different from the credential device, the video data including images of one or more persons; and correlating movement of the one or more persons detected in the video data with the received IMU information to identify a person in the video data as a holder in possession of the credential device.

In Example 20, the subject matter of Example 19 optionally includes instructions that cause the machine to perform operations including; identifying body key points of a person of the one or persons in the images of the video data; calculating correlation coefficients that correlate movement of the identified body key points and the received IMU information; and identifying the person in the video data as the holder in possession of the credential device according to the calculated correlation coefficients.

In Example 21, the subject matter of one or both of Examples 19 and 20 optionally include instructions that cause the machine to perform operations of a machine learning algorithm to identify the holder in possession of the credential device in the video data. The performing the operations of a machine learning algorithm includes receiving correlated training IMU information and video data; detecting one or more images in the training video match; matching the training IMU information to the detected one or more images; receiving feedback information of the correctness of the matching; updating the machine learning model using the feedback information; applying the IMU information received from the credential device to the updated machine learning algorithm; applying the video data received from the separate device to the updated machine learning algorithm; detecting images of the one or more persons in the video data using the updated machine learning algorithm; and matching the IMU information to the detected images using the updated machine learning model to identify the holder in possession of the credential device.

These non-limiting Examples can be combined in any permutation or combination. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

What is claimed is:

1. A method of operating a seamless physical access control (PAC) system, the method comprising:
receiving, by a verification device of the PAC system, credential information from a credential device;
receiving inertial measurement unit (IMU) information from the credential device;
receiving video data from another device different from the credential device, the video data including images of one or more persons; and
correlating, by the verification device, movement of the one or more persons detected in the video data with the received IMU information to identify a person in the video data as a holder in possession of the credential device.

2. The method of claim 1, wherein the correlating movement includes:
identifying body key points of a person of the one or persons in the images of the video data;
calculating correlation coefficients that correlate movement of the identified body key points and the received IMU information; and
identifying the person in the video data as the holder according to the calculated correlation coefficients.

3. The method of claim 1, wherein the correlating movement includes:
determining a change in one or both of frequency and phase of movement of one or more body key points in images of the video data;
determining a change in one or both of frequency and phase of the IMU information; and
correlating the change in the one or both of frequency and phase of the IMU information with the change in one or both of frequency and phase of movement of the one or more body key points in images of the video data to identify the holder in the images of the video data.

4. The method of claim 1, wherein the correlating movement includes:
training a machine learning model, implemented by one or more processors of the PAC system, using correlated training IMU information and video data;
inputting the IMU information received from the credential device and the video data received from the separate device into the machine learning model;
detecting images of the one or more persons in the video data using the machine learning model; and
matching the IMU information to the detected images using the machine learning model to identify the holder in possession of the credential device.

5. The method of claim 4, wherein inputting the IMU information and the video data includes inputting the IMU information received from the credential device into one portion of the neural network and inputting the video data received from the separate device into a second portion of the neural network.

6. The method of claim 4,
wherein training a machine learning model includes updating weights of connections of a neural network using the correlated training IMU information and video data to update the neural network; and
wherein the matching the IMU information to the detected images includes matching the IMU information to the detected images using the updated neural network.

7. The method of claim 1, including:
authenticating the credential information;
processing subsequent video data that includes the holder of the credential device; and
initiating access to a controlled access portal according to the credential information and the location of the holder of the credential device relative to the controlled access portal.

8. The method of claim 1, wherein the video data includes images of multiple persons, and the method further includes;
receiving credential information from multiple credential devices;
identifying holders of the multiple credential devices in the video data; and
generating an alert when detecting a person of the multiple persons in the video data that is not in possession of a credential device.

9. The method of claim 1, including presenting identification of the identified holder of the credential device on a display of a user interface of the PAC system.

10. A verification device of a physical access control (PAC) system, the verification device comprising:
physical layer circuitry configured to transmit and receive radio frequency electrical signals with a radio access network;
at least one hardware processor operatively coupled to the physical layer circuitry; and
a memory storing instructions that cause the at least one hardware processor to perform operations including:
establish a communication session with a credential device using the radio access network;
receive credential information from the credential device;
receive inertial measurement unit (IMU) information from the credential device;
obtain video data generated by a device different from the credential device;
correlate movement of an image of a person in the video data with the received IMU information; and
identify the person in the video data as a holder in possession of the credential device.

11. The verification device of claim 10, wherein the instructions cause the at least one hardware processor to:
identify body key points of a person of the one or persons in the images of the video data;
calculate correlation coefficients that correlate movement of the identified body key points and the received IMU information; and
identify the person in the video data as the holder according to the calculated correlation coefficients.

12. The verification device of claim 10, wherein the instructions cause the at least one hardware processor to:
determine a change in one or both of frequency and phase of movement of one or more body key points in images of the video data;
determine a change in one or both of frequency and phase of the IMU information; and
correlate the change in the one or both of frequency and phase of the IMU information with the change in one or both of frequency and phase of movement of the one or more body key points in images of the video data to identify the holder in the images of the video data.

13. The verification device of claim 10, wherein the instructions cause the at least one hardware processor to perform a machine learning model to identify the holder in possession of the credential device in the video data, including:
receive correlated training IMU information and video data;
update the machine learning model using the training IMU information and video data;
apply the IMU information received from the credential device to the machine learning model;
apply the video data received from the separate device to the machine learning model;
detect images of the one or more persons in the video data using the machine learning model; and
match the IMU information to the detected images using the machine learning model to identify the holder in possession of the credential device.

14. The verification device of claim 13, wherein the instructions cause the at least one hardware processor to implement a neural network to identify the holder in possession of the credential device in the video data, including:
updating the neural network by updating weights of connections of the neural network using feedback information of the correctness of correlation of the training IMU information and video data; and
matching the IMU information to the detected images using the updated neural network.

15. The verification device of claim 10, wherein the instructions cause the at least one hardware processor to:
authenticate the credential information;
process subsequent video data that includes the holder of the credential device; and
initiate access to a physical access portal according to the credential information and the location of the holder of the credential device relative to the physical access portal.

16. The verification device of claim 10, wherein the instructions cause the at least one hardware processor to:
receive credential information from multiple credential devices;
identify holders of the multiple credential devices in the video data; and
generate an alert when detecting a person of the multiple persons in the video data that is not in possession of a credential device.

17. The verification device of claim 10, wherein the instructions cause the at least one hardware processor to: present identification of the holder of the credential device on a display of a user interface of the PAC system.

18. The verification device of claim 10, including a camera to generate the video data.

19. A computer-readable storage medium including instructions that, when executed by one or more processors of a machine, configure the machine to perform operations comprising:
receiving credential information from a credential device;
receiving inertial measurement unit (IMU) information from the credential device;
receiving video data from another device different from the credential device, the video data including images of one or more persons; and
correlating movement of the one or more persons detected in the video data with the received IMU information to identify a person in the video data as a holder in possession of the credential device.

20. The computer-readable storage medium of claim 19, including instructions that cause the machine to perform operations including:
identifying body key points of a person of the one or persons in the images of the video data;
calculating correlation coefficients that correlate movement of the identified body key points and the received IMU information; and
identifying the person in the video data as the holder in possession of the credential device according to the calculated correlation coefficients.

21. The computer-readable storage medium of claim 19, including instructions that cause the machine to perform operations of a machine learning algorithm to identify the holder in possession of the credential device in the video data, including:
receive correlated training IMU information and video data;
detect one or more images in the training video match;
match the training IMU information to the detected one or more images;
receive feedback information of the correctness of the matching;
update the machine learning model using the feedback information;
apply the IMU information received from the credential device to the updated machine learning algorithm;
apply the video data received from the separate device to the updated machine learning algorithm;
detect images of the one or more persons in the video data using the updated machine learning algorithm; and
match the IMU information to the detected images using the updated machine learning model to identify the holder in possession of the credential device.
